(19) United States
(12) Patent Application Publication
(10) Pub. No.: US 2025/0133422 A1
(43) Pub. Date: Apr. 24, 2025

(54) DATA TRANSMISSION OPTIMIZATION

(71) Applicant: Tencent Technology (Shenzhen) Company Limited, Shenzhen (CN)

(72) Inventors: Yuhang JIA, Shenzhen (CN); Yixue LEI, Shenzhen (CN); Yunfei ZHANG, Shenzhen (CN)

(73) Assignee: Tencent Technology (Shenzhen) Company Limited, Shenzhen (CN)

(21) Appl. No.: 19/002,552

(22) Filed: Dec. 26, 2024

Related U.S. Application Data
(63) Continuation of application No. PCT/CN2023/103030, filed on Jun. 28, 2023.

(30) Foreign Application Priority Data
Nov. 25, 2022 (CN) 202211494677.6

(51) Int. Cl. H04W 24/02; H04W 28/02

(52) U.S. Cl. CPC H04W 24/02; H04W 28/0247

(57) ABSTRACT

According to an aspect, a method of data transmission optimization includes obtaining, by an application layer transmission optimization (ALTO) client, and based on a data network (DN), transmission information of an access network. The transmission information of the access network being exposed by an access network device to the DN. ALTO information that is provided by an ALTO server is obtained. The data transmission optimization of the ALTO client is performed based on the ALTO information and the transmission information of the access network. Apparatus and non-transitory computer-readable storage medium counterpart embodiments are also contemplated.

### RELATED APPLICATIONS

The present application is a continuation of International Application No. PCT/CN2023/103030, entitled “DATA TRANSMISSION OPTIMIZATION METHOD AND APPARATUS, COMPUTER-READABLE MEDIUM, AND ELECTRONIC DEVICE” and filed on Jun. 28, 2023, which claims priority to Chinese Patent Application No. 202211494677.6, entitled “DATA TRANSMISSION OPTIMIZATION METHOD AND APPARATUS, COMPUTER-READABLE MEDIUM, AND ELECTRONIC DEVICE” and filed on Nov. 25, 2022. The entire disclosures of the prior applications are hereby incorporated by reference.

### FIELD OF THE TECHNOLOGY

This disclosure relates to the field of computer and communication technologies, including data transmission optimization.

### BACKGROUND OF THE DISCLOSURE

Application layer transmission optimization (ALTO) technologies are configured for providing network topology information and network optimization services to suppliers, so as to guide a user equipment (UE for short) to access nearby resources, thereby reducing network traffic and improving access quality.

### SUMMARY

Embodiments of this disclosure provide a data transmission optimization method and apparatus, a computer-readable medium, and an electronic device, so as to integrate relatively comprehensive information to implement optimization of data transmission, thereby improving data transmission efficiency of a network.

According to an aspect, a method of data transmission optimization includes obtaining, by an application layer transmission optimization (ALTO) client, and based on a data network (DN), transmission information of an access network, the transmission information of the access network being exposed by an access network device to the DN; obtaining ALTO information that is provided by an ALTO server; and performing the data transmission optimization of the ALTO client based on the ALTO information and the transmission information of the access network.

According to another aspect, a method of data transmission optimization includes receiving an ALTO information obtaining request transmitted by an ALTO client; and exposing ALTO information to the ALTO client based on the ALTO information obtaining request, the ALTO information is used by the ALTO client that performs the data transmission optimization based on the ALTO information and transmission information of an access network, the transmission information of the access network is exposed by an access network device to the ALTO client via a DN.

The embodiments of this disclosure provide a data transmission optimization method, including: obtaining, based on a data network (DN), transmission information of an access network exposed by an access network device, the transmission information of the access network being exposed by the access network device to the DN; obtaining application layer transmission optimization (ALTO) information provided by an ALTO server; and performing data transmission optimization of an ALTO client based on the ALTO information and the transmission information of the access network.

The embodiments of this disclosure provide a data transmission optimization method, including: receiving an ALTO information obtaining request transmitted by an ALTO client; and exposing the ALTO information to the ALTO client based on the ALTO information obtaining request, so that the ALTO client performs data transmission optimization of the ALTO client based on the ALTO information and transmission information of an access network exposed by an access network device, the transmission information of the access network being exposed by the access network device to a DN, and obtained by the ALTO client from the DN.

The embodiments of this disclosure provide a data transmission optimization apparatus, including: an obtaining unit, configured to: obtain, based on a DN, transmission information of an access network exposed by an access network device, the transmission information of the access network being exposed by the access network device to the DN; and obtain ALTO information provided by an ALTO server; and a processing unit, configured to perform data transmission optimization of an ALTO client based on the ALTO information and the transmission information of the access network.

The embodiments of this disclosure provide a data transmission optimization apparatus, including: a receiving unit, configured to receive an ALTO information obtaining request transmitted by an ALTO client; and a transmitting unit, configured to expose the ALTO information to the ALTO client based on the ALTO information obtaining request, so that the ALTO client performs data transmission optimization of the ALTO client based on the ALTO information and transmission information of an access network exposed by an access network device, the transmission information of the access network being exposed by the access network device to a DN, and obtained by the ALTO client from the DN.

The embodiments of this disclosure provide a computer-readable medium, having a computer program stored therein, the computer program, when executed by a processor, implementing the data transmission optimization method in the foregoing embodiments.

The embodiments of this disclosure provide an electronic device, including: one or more processors; and a storage apparatus, configured to store one or more computer programs, the one or more computer programs, when executed by the one or more processors, causing the electronic device to implement the data transmission optimization method in the foregoing embodiments.

The embodiments of this disclosure provide a computer program product, including a computer program, the computer program being stored in a computer-readable storage medium. A processor of an electronic device reads and executes the computer program from the computer-readable storage medium, so that the electronic device performs the data transmission optimization method provided in the foregoing various optional embodiments.

In the technical solutions provided in some embodiments of this disclosure, the transmission information of the access network exposed by the access network device is obtained based on the DN, and the ALTO information provided by the ALTO server is obtained, so as to perform data transmission optimization of the ALTO client based on the ALTO information and the transmission information of the access network, so that the ALTO client can consider the ALTO information provided by the ALTO server and the transmission information of the access network exposed by the access network device when performing the data transmission optimization. In this way, relatively comprehensive information may be integrated to implement optimization of data transmission, so as to select a relatively appropriate end-to-end transmission path, thereby improving the data transmission efficiency of the network.

The foregoing general descriptions and the following detailed descriptions are examples and explanatory only and are not intended to limit this disclosure.

### BRIEF DESCRIPTION OF THE DRAWINGS

FIG. 1 is a schematic diagram showing a system architecture for implementing application layer transmission optimization (ALTO) optimization based on a 5G network.

FIG. 2 is a flowchart of a data transmission optimization method according to some embodiments of this disclosure.

FIG. 3 is a flowchart of a data transmission optimization method according to some embodiments of this disclosure.

FIG. 4 is a flowchart of a data transmission optimization method according to some embodiments of this disclosure.

FIG. 5 is a flowchart of a data transmission optimization method according to some embodiments of this disclosure.

FIG. 6 is a flowchart of a data transmission optimization method according to some embodiments of this disclosure.

FIG. 7 is a flowchart of a data transmission optimization method according to some embodiments of this disclosure.

FIG. 8 is a block diagram of a data transmission optimization apparatus according to some embodiments of this disclosure.

FIG. 9 is a block diagram of a data transmission optimization apparatus according to some embodiments of this disclosure.

FIG. 10 is a schematic structural diagram of a computer system adapted to implement an electronic device according to an embodiment of this disclosure.

### DESCRIPTION OF EMBODIMENTS

Example implementations are described in a more comprehensive manner with reference to the accompanying drawings. However, the example implementations can be implemented in various forms, and are not to be construed as being limited to only these examples. On the contrary, the purpose of providing the implementations is to make this disclosure more comprehensive and complete, and to fully convey the concept of the example implementations to a person skilled in the art.

In addition, features, structures, or characteristics described in this disclosure may be combined in one or more embodiments in any proper manner. In the following descriptions, many specific details are provided to provide a thorough understanding of the embodiments of this disclosure. However, a person skilled in the art is to be aware that, during implementation of the technical solutions in this disclosure, not all detailed features in the embodiments need to be used, one or more specific details may be omitted, or another method, unit, apparatus, operation, or the like may be used.

The block diagrams shown in the accompanying drawings are merely functional entities and do not necessarily correspond to physically independent entities. To be specific, the functional entities may be implemented in a software form, or in one or more hardware modules or integrated circuits, or in different networks and/or processor apparatuses and/or microcontroller apparatuses.

The flowcharts shown in the accompanying drawings are merely example descriptions, and do not necessarily include all content and operations/blocks, nor do they have to be executed in the described order. For example, some operations/blocks may further be broken down, but some operations/blocks may be merged or partially merged. Therefore, an actual execution order may change according to an actual situation.

“A plurality of” mentioned herein means two or more. The term “and/or” is used for describing an association relationship between associated objects and representing that three relationships may exist. For example, A and/or B may represent the following three cases: only A exists, both A and B exist, and only B exists. The character “/” generally indicates an “or” relationship between a preceding associated object and a latter associated object.

Descriptions of terms in this disclosure are provided as examples only and are not intended to limit the scope of the disclosure.

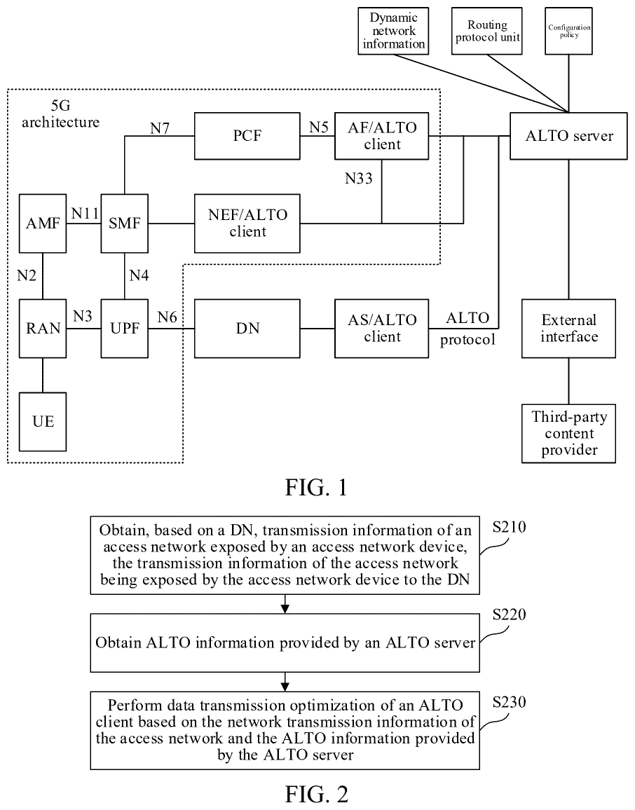

FIG. 1 is a schematic diagram of a system architecture for implementing application layer transmission optimization (ALTO) optimization based on a 5G network. As shown in FIG. 1, AF stands for application function, which may also serve as an application server (AS). The AF may implement a control plane function of a third-party AS, and perform interaction through an AF-network exposure function (NEF)-policy control function (PCF) or AF-PCF. The AS may implement a user plane function (UPF) of the third-party AS, i.e., an AS-IP transmission network-UPF interface.

SMF stands for session management function, which is responsible for tunnel maintenance, IP address assignment and management, UPF selection, control of policy implementation and quality of service (QOS), charging data collection, service roaming, and the like.

AMF stands for access and mobility management function, which is mainly configured to perform registration, connection, accessibility, and mobility management, and is also configured to provide a session management message transmission channel for a user equipment (UE) and the SMF, and provide identification and authentication functions for UE access. The AMF is a core network control plane access point of the UE and a radio access network (RAN).

PCF stands for policy control function, which is mainly configured to manage a unified policy framework and provide policy rules for control plane functions.

UPF stands for user plane function, which is responsible for packet routing and forwarding, policy implementation, traffic reporting, QoS handling, and the like.

The NEF is located between a 5G core network and external third-party application functionaries (and possibly some internal AFs), and is responsible for managing the external network exposure data, and all external applications that want to access the internal data of the 5G core network need to pass through the NEF. The NEF provides corresponding security guarantees to ensure the security of external applications to a network side, and the NEF also provides functions such as QoS customization exposure ability of external applications, mobility state event subscription, and AF request distribution.

DN stands for data network, which may also be referred to as an external network. In a 5G system, one of key tasks of the network is providing a connection to the DN for a terminal, for example, a DNN under the 5G. The DN may be the Internet, an IP multimedia subsystem (IMS), or the like.

The UE is a user terminal, which may include one or more of a smartphone, a tablet computer, a notebook computer, a desktop computer, a smart speaker, a smartwatch, an on-board terminal, a smart television, and the like.

An ALTO server is a server of an ALTO architecture. The ALTO is an ALTO protocol based on the IP layer, which is responsible for providing a basic network location structure and network path preference, with the goal of modifying the network resource consumption pattern while maintaining or improving application performance. Correspondingly, the ALTO client is a client of the ALTO architecture.

A third-party content provider is responsible for providing services for applications, for example, a video content provider and a news content provider.

Dynamic network information is IP-based dynamic network information in the ALTO architecture.

A routing protocol unit includes routing protocols. A routing protocol unit in the ALTO architecture is an IP-based routing protocol unit.

A configuration policy, namely, a provisioning policy, is an ALTO-based network configuration information policy in the ALTO architecture.

Since the ALTO solution provided in the related art fails to fully consider the relevant information of the network, network transmission efficiency is restricted to some extent. Therefore, based on the system architecture shown in FIG. 1 in the embodiments of this disclosure, it is proposed that the ALTO client may obtain transmission information of an access network exposed by an access network device, and obtain ALTO information provided by an ALTO server, to perform data transmission optimization of the ALTO client based on the ALTO information and the transmission information of the access network. In this way, relatively comprehensive information may be integrated to implement optimization of data transmission, so as to select a relatively appropriate end-to-end transmission path, and then data transmission efficiency of a network may be improved.

Implementation details of the technical solutions of the embodiments of this disclosure are described in detail below.

FIG. 2 is a flowchart of a data transmission optimization method according to some embodiments of this disclosure. The data transmission optimization method may be performed by an ALTO client. Referring to FIG. 2, the data transmission optimization method includes at least operation S210 to operation S230. The detailed description is as follows.

In S210, transmission information of an access network exposed by an access network device is obtained based on a DN, the transmission information of the access network being exposed by the access network device to the DN.

In some embodiments, a process of obtaining the transmission information of the access network exposed by the access network device based on the DN may be: obtaining the transmission information of the access network exposed by the access network device from the DN. In this case, after the access network device (such as a base station) obtains the transmission information of the access network, the transmission information of the access network may be transmitted to a UPF, and then the transmission information of the access network is transmitted by the UPF to the DN. In some embodiments, the UPF may transmit the transmission information of the access network to the DN through an interface N6.

In some embodiments, the transmission information of the access network includes at least one of the following: wireless link state information, throughput, transmission delay information, and delay jitter information of an access network.

The wireless link state may be measured through parameters such as a signal to interference plus noise ratio (SINR), a reference signal receiving power (RSRP), reference signal receiving quality (RSRQ), and a received signal strength indication (RSSI). The transmission delay information may be information such as a transmission delay of a data packet. The delay jitter information may be change information of the transmission delay, or the like.

In S220, ALTO information provided by an ALTO server is obtained.

In some embodiments, the ALTO client may obtain, from a core network device, the ALTO information provided by the ALTO server. In this case, the ALTO information is obtained by another ALTO client from the ALTO server and transmitted to the core network device. For example, the ALTO client close to a UPF may identify the ALTO server through an ALTO service discovery process. After the ALTO server is identified, an ALTO information obtaining request may be transmitted to the ALTO server, to obtain the ALTO information from the ALTO server. After the ALTO information is obtained, the ALTO client may transmit the obtained ALTO information to the core network device through a DN via an external interface.

In some embodiments, a process of obtaining, from the core network device by the ALTO client, the ALTO information provided by the ALTO server may be obtaining the ALTO information from a NEF. In this case, another ALTO client obtains the ALTO information from the ALTO server and then transmits the ALTO information to the NEF through the DN.

In some embodiments, a process of obtaining, from the core network device by the ALTO client, the ALTO information provided by the ALTO server may be obtaining the ALTO information from the AF. In this case, another ALTO client obtains the ALTO information from the ALTO server and then transmits the ALTO information to the NEF through the DN, and then the ALTO information is transmitted by the NEF to the AF.

In some embodiments, the process of obtaining, by the ALTO client, the ALTO information provided by the ALTO server may be performing the ALTO service discovery process, then transmitting the ALTO information obtaining request to the ALTO server after identifying the ALTO server, and then receiving the ALTO information fed back by the ALTO server.

In some embodiments, when the ALTO client receives the ALTO information fed back by the ALTO server, the ALTO information may further be transmitted to the core network device through the DN, so that the core network device exposes the ALTO information to the another ALTO client. For example, the ALTO client may transmit the ALTO information to a UPF entity through the DN, and then the ALTO information is provided by the UPF to the another ALTO client through a NEF entity. In some embodiments, the NEF may directly expose the ALTO information to the another ALTO client, or may transmit the ALTO information to the AF, and then the ALTO information is exposed by the AF to the another ALTO client.

In some embodiments, the ALTO information may include at least one of the following: IP-based dynamic network information, IP-based routing protocol unit information, and ALTO-based network configuration policy information.

Still referring to FIG. 2, in S230, data transmission optimization of the ALTO client is performed based on the transmission information of the access network and the ALTO information provided by the ALTO server.

In some embodiments, since the ALTO client obtains the transmission information of the access network and the ALTO information provided by the ALTO server, relatively comprehensive information may be integrated to implement optimization of data transmission. In some embodiments, the data transmission optimization process of the ALTO client may be data transmission optimization at an application layer, or may be optimization at a transport layer. For example, a division mode of data packets at the application layer and a data packet size may be adjusted by selecting a relatively appropriate end-to-end transmission path, to improve data transmission efficiency of a network.

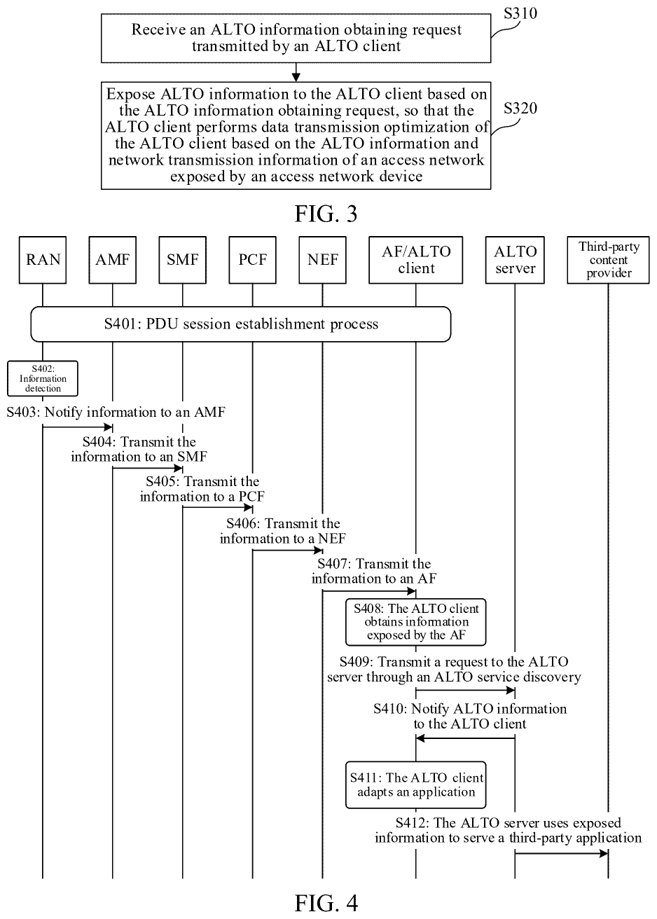

The technical solution of the embodiment shown in FIG. 2 is described from a perspective of the ALTO client. The technical solution of this embodiment of this disclosure is described again from the perspective of the ALTO server with reference to FIG. 3.

FIG. 3 is a flowchart of a data transmission optimization method according to an embodiment of this disclosure. The data transmission optimization method may be performed by an ALTO server. Referring to FIG. 3, the data transmission optimization method includes at least operation S310 to operation S320. The detailed description is as follows.

In S310, an ALTO information obtaining request transmitted by an ALTO client is received.

In some embodiments, the ALTO client may perform an ALTO service discovery process, then transmit the ALTO information obtaining request to the ALTO server after identifying the ALTO server, and then feed back ALTO information to the ALTO client after the ALTO server receives the ALTO information obtaining request.

In S320, the ALTO information is exposed to the ALTO client based on the ALTO information obtaining request, so that the ALTO client performs data transmission optimization of the ALTO client based on the ALTO information and transmission information of an access network exposed by an access network device, the transmission information of the access network being exposed by the access network device to a DN, and obtained by the ALTO client from the DN.

In some embodiments, for the process of obtaining, by the ALTO client, the transmission information of the access network from the DN and the process of performing the data transmission optimization of the ALTO client based on the ALTO information and the transmission information of the access network exposed by the access network device, reference may be made to the technical solutions of the foregoing embodiments. Details are not described again.

Implementation details of the technical solutions of the embodiments of this disclosure are described below in detail by using a process in which a plurality of entities interact as an example with reference to FIG. 4 to FIG. 7.

As shown in FIG. 4, a data transmission optimization method according to an embodiment of this disclosure includes the following operations.

S401: Perform a PDU session establishment process between a RAN and an AF.

In some embodiments, an ALTO client and the AF may be respectively used as a network element, or may be merged into a network element.

S402: The RAN performs an information detection process.

In some embodiments, a RAN side may detect and collect information at a specific frequency. The information mainly includes information of a base station side and transmission information for each UE, for example, may include network state information, throughput, delay, and jitter. The network state information includes an SINR, an RSSI, an RSRP, an RSRQ, and the like. Based on service requirements, the information may be used as mandatory information or alternative information.

S403: The RAN notifies detected RAN-side related information to an AMF.

S404: The AMF transmits the RAN-side related information to an SMF.

In some embodiments, with reference to FIG. 1, the AMF may transmit an Nsmf_PDUSession_UpdateSM message to the SMF through an interface N11. The message is converted from the information transmitted from the RAN side received by the AMF, and the message includes the RAN-side related information.

S405: The SMF transmits the RAN-side related information to a PCF.

In some embodiments, with reference to FIG. 1, the SMF may transmit an Npcf_SMPolicyControl_Update message to the PCF through an interface N7. The message is converted from the information transmitted from the AMF side received by the SMF, and the message includes the RAN-side related information.

S406: The PCF transmits the RAN-side related information to a NEF.

In some embodiments, the PCF may transmit an Npcf_PolicyAuthorization_Notify message to the NEF through an interface N5. The message is converted from the information transmitted from the SMF side received by the PCF, and the message includes the RAN-side related information.

S407: The NEF transmits the RAN-side related information to the AF.

In some embodiments, the NEF may transmit an Nnef_EventExposure message to the AF through an interface N33. The message is converted from the information transmitted from the PCF side received by the NEF, and the message includes the RAN-side related information.

S408: The ALTO client obtains information exposed by the AF.

In some embodiments, since the RAN-side related information has been transmitted from the NEF to the AF, the ALTO client may obtain the RAN-side related information from the information exposed by the AF.

S409: The ALTO client transmits a request to the ALTO server through an ALTO service discovery.

In some embodiments, the ALTO client may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.

S410: The ALTO server notifies the ALTO information to the ALTO client.

In some embodiments, the ALTO server may feed back the ALTO information of the ALTO server to the ALTO client after receiving the request transmitted by the ALTO client.

S411: The ALTO client integrates the RAN-side related information and the ALTO information to adapt to an application.

In some embodiments, the ALTO client may aggregate and analyze the RAN-side related information and the ALTO information after obtaining the two types of information, to implement optimization of data transmission. For example, the optimization of data transmission may be data transmission optimization at an application layer, or may be optimization at a transport layer. In an aspect, a division mode of data packets at the application layer and a data packet size may be adjusted by selecting a relatively appropriate end-to-end transmission path, to improve data transmission efficiency of a network.

S412: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In the embodiment shown in FIG. 4, the RAN-side related information is exposed from a control plane (such as the NEF and the AF), and then an end-to-end data transmission path is selected by the ALTO client based on the ALTO information provided by the ALTO server to perform the data transmission optimization.

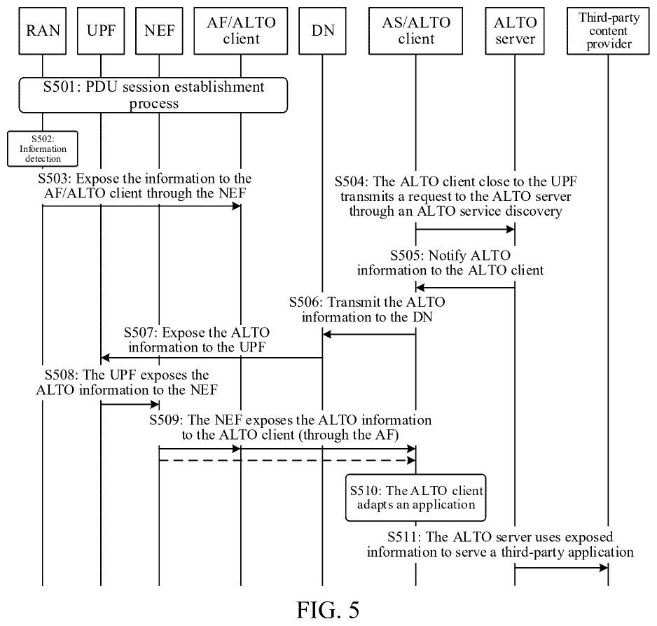

As shown in FIG. 5, a data transmission optimization method according to an embodiment of this disclosure includes the following operations.

S501: Perform a PDU session establishment process between a RAN and an AF.

In some embodiments, an ALTO client and the AF may be respectively used as a network element, or may be merged into a network element.

S502: The RAN performs an information detection process.

In some embodiments, a RAN side may detect and collect information at a specific frequency. The information mainly includes information of a base station side and transmission information for each UE, for example, may include network state information, throughput, delay, and jitter. The network state information includes an SINR, an RSSI, an RSRP, an RSRQ, and the like. Based on service requirements, the information may be used as mandatory information or alternative information.

S503: The RAN exposes the information to the AF/ALTO client through a NEF.

In some embodiments, the RAN may notify detected RAN-side related information to the AMF. The AMF transmits the RAN-side related information to the SMF, the SMF transmits the RAN-side related information to a PCF, the PCF transmits the RAN-side related information to the NEF, and then the NEF transmits the RAN-side related information to the AF. In this way, the ALTO client may obtain the RAN-side related information from the AF.

In some embodiments, the AMF may transmit an Nsmf_PDUSession_UpdateSM message to the SMF through an interface N11. The message is converted from the information transmitted from the RAN side received by the AMF. The SMF may transmit an Npcf_SMPolicyControl_Update message to the PCF through an interface N7. The message is converted from the information transmitted from the AMF side received by the SMF. The PCF may transmit an Npcf_PolicyAuthorization_Notify message to the NEF through an interface N5. The message is converted from the information transmitted from the SMF side received by the PCF. The NEF may transmit an Nnef_EventExposure message to the AF through an interface N33. The message is converted from the information transmitted from the PCF side received by the NEF.

S504: The ALTO client close to a UPF transmits a request to the ALTO server through an ALTO service discovery.

In some embodiments, the ALTO client close to the UPF may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.

S505: The ALTO server notifies the ALTO information to the ALTO client.

In some embodiments, the ALTO server may feed back the ALTO information of the ALTO server to the ALTO client after receiving the request transmitted by the ALTO client.

S506: The ALTO client transmits the ALTO information to a DN.

In some embodiments, the ALTO client may transmit the ALTO information to the DN (namely, the Internet) through an external interface. In some embodiments, the ALTO client may transmit the RAN-side related information to the DN and perform the following similar operations S507-S509 on the ALTO information.

S507: The DN exposes the ALTO information to the UPF.

In some embodiments, the DN may expose the ALTO information to the UPF through an interface N6.

S508: The UPF exposes the ALTO information to the NEF.

In some embodiments, the UPF may expose the ALTO information to the SMF through an interface N4, then the SMF transmits the ALTO information to the PCF, and the PCF transmits the ALTO information to the NEF.

S509: The NEF exposes the ALTO information to the ALTO client (through the AF).

In some embodiments, the NEF may expose the ALTO information to the ALTO client in two manners. A first manner is directly exposing the ALTO information to the ALTO client by the NEF, and the other manner is transmitting Nnef_EventExposure information to the AF by the NEF, and then exposing the ALTO information to the ALTO client by the AF.

S510: The ALTO client integrates the RAN-side related information and the ALTO information to adapt to an application.

In some embodiments, the ALTO client may aggregate and analyze the RAN-side related information and the ALTO information after obtaining the two types of information, to implement optimization of data transmission. For example, the optimization of data transmission may be data transmission optimization at an application layer, or may be optimization at a transport layer. In an aspect, a division mode of data packets at the application layer and a data packet size may be adjusted by selecting a relatively appropriate end-to-end transmission path, to improve data transmission efficiency of a network.

S511: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In the embodiment shown in FIG. 5, a plurality of ALTO clients may respectively network exposure information (for example, the RAN-side related information) from a control plane (the AF, the NEF, or the like) and a user plane (the UPF, the DN, or the like), and then an end-to-end data transmission path is selected by the ALTO client based on the ALTO information provided by the ALTO server to perform the data transmission optimization. The network exposure information may be selected on the user plane and the control plane (the same information is transmitted only from the user plane or only from the control plane), and backed up and supplemented (the same information is available on both the control plane and the user plane, and backed up and supplemented each other).

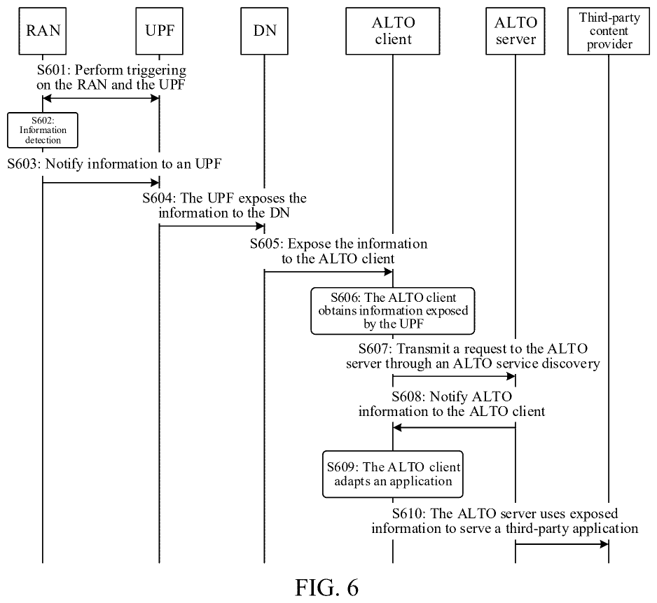

As shown in FIG. 6, a data transmission optimization method according to some embodiments of this disclosure includes the following operations.

S601: Perform triggering on a RAN and a UPF.

In an aspect, a RAN side and the UPF respectively trigger a response, and perform a network information exposure service through a user plane.

S602: The RAN performs an information detection process.

In some embodiments, a RAN side may detect and collect information at a specific frequency. The information mainly includes information of a base station side and transmission information for each UE, for example, may include network state information, throughput, delay, and jitter. The network state information includes an SINR, an RSSI, an RSRP, an RSRQ, and the like. Based on service requirements, the information may be used as mandatory information or alternative information.

S603: The RAN notifies the information to the UPF.

In some embodiments, the RAN may notify detected RAN-side related information to the UPF through an interface N3.

S604: The UPF exposes the information to a DN.

In some embodiments, the UPF may expose the RAN-side related information to the DN through an interface N6.

S605: The DN exposes the information to an ALTO client.

In some embodiments, the DN may expose the RAN-side related information to the ALTO client through an external interface.

S606: The ALTO client obtains the information exposed by the UPF.

In some embodiments, the RAN-side related information has been exposed to the DN by the UPF. Therefore, the ALTO client may obtain the RAN-side related information.

S607: The ALTO client transmits a request to the ALTO server through an ALTO service discovery.

In some embodiments, the ALTO client may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.

S608: The ALTO server notifies the ALTO information to the ALTO client.

In some embodiments, the ALTO server may feed back the ALTO information of the ALTO server to the ALTO client after receiving the request transmitted by the ALTO client.

S609: The ALTO client integrates the RAN-side related information and the ALTO information to adapt to an application.

In some embodiments, the ALTO client may aggregate and analyze the RAN-side related information and the ALTO information after obtaining the two types of information, to implement optimization of data transmission. For example, the optimization of data transmission may be data transmission optimization at an application layer, or may be optimization at a transport layer. In an aspect, a division mode of data packets at the application layer and a data packet size may be adjusted by selecting a relatively appropriate end-to-end transmission path, to improve data transmission efficiency of a network.

S610: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In the embodiment shown in FIG. 6, the RAN-side related information is exposed from the user plane (for example, the UPF and the DN), and then an end-to-end data transmission path is selected by the ALTO client based on the ALTO information provided by the ALTO server to perform the data transmission optimization.

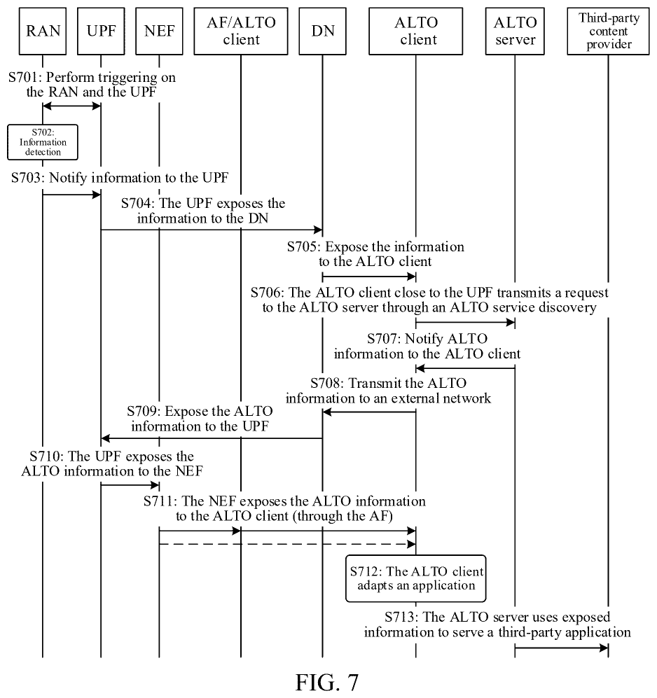

As shown in FIG. 7, a data transmission optimization method according to an embodiment of this disclosure includes the following operations.

S701: Perform triggering on a RAN and a UPF.

In an aspect, a RAN side and the UPF respectively trigger a response, and perform a network information exposure service through a user plane.

S702: The RAN performs an information detection process.

In some embodiments, a RAN side may detect and collect information at a specific frequency. The information mainly includes information of a base station side and transmission information for each UE, for example, may include network state information, throughput, delay, and jitter. The network state information includes an SINR, an RSSI, an RSRP, an RSRQ, and the like. Based on service requirements, the information may be used as mandatory information or alternative information.

S703: The RAN notifies the information to the UPF.

In some embodiments, the RAN may notify detected RAN-side related information to the UPF through an interface N3.

S704: The UPF exposes the information to a DN.

In some embodiments, the UPF may expose the RAN-side related information to the DN through an interface N6.

S705: The DN exposes the information to an ALTO client.

In some embodiments, the DN may expose the RAN-side related information to the ALTO client through an external interface. The RAN-side related information has been exposed to the DN by the UPF. Therefore, the ALTO client may obtain the RAN-side related information.

S706: The ALTO client close to a UPF transmits a request to the ALTO server through an ALTO service discovery.

In some embodiments, the ALTO client close to the UPF may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.

S707: The ALTO server notifies the ALTO information to the ALTO client.

In some embodiments, the ALTO server may feed back the ALTO information of the ALTO server to the ALTO client after receiving the request transmitted by the ALTO client.

S708: The ALTO client transmits the ALTO information to the DN.

In some embodiments, the ALTO client may transmit the ALTO information to the DN (namely, the Internet) through an external interface. In some embodiments, the ALTO client may further transmit the RAN-side related information to the DN and perform the following similar operations S709-S711 on the ALTO information.

S709: The DN exposes the ALTO information to the UPF.

In some embodiments, the DN may expose the ALTO information to the UPF through an interface N6.

S710: The UPF exposes the ALTO information to the NEF.

In some embodiments, the UPF may expose the ALTO information to the SMF through an interface N4, then the SMF transmits the ALTO information to the PCF, and the PCF transmits the ALTO information to the NEF.

S711: The NEF exposes the ALTO information to the ALTO client (through the AF).

In some embodiments, the NEF may expose the ALTO information to the ALTO client in two manners. A first manner is directly exposing the ALTO information to the ALTO client by the NEF, and the other manner is transmitting Nnef_EventExposure information to the AF by the NEF, and then exposing the ALTO information to the ALTO client by the AF.

S712: The ALTO client integrates the RAN-side related information and the ALTO information to adapt to an application.

In some embodiments, the ALTO client may aggregate and analyze the RAN-side related information and the ALTO information after obtaining the two types of information, to implement optimization of data transmission. For example, the optimization of data transmission may be data transmission optimization at an application layer, or may be optimization at a transport layer. In an aspect, a division mode of data packets at the application layer and a data packet size may be adjusted by selecting a relatively appropriate end-to-end transmission path, to improve data transmission efficiency of a network.

S713: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In the embodiment shown in FIG. 7, a plurality of ALTO clients may expose network information (for example, the RAN-side related information) from the user plane (the UPF, the DN, or the like), and then an end-to-end data transmission path is selected by the ALTO client based on the ALTO information provided by the ALTO server to perform the data transmission optimization.

In the technical solutions of the foregoing embodiments of this disclosure, the ALTO client can consider the ALTO information provided by the ALTO server and the transmission information of the access network (namely, the RAN-side related information) exposed by the access network device when the data transmission optimization is performed. In this way, relatively comprehensive information may be integrated to implement optimization of data transmission, so as to select the relatively appropriate end-to-end transmission path, thereby improving the data transmission efficiency of the network.

Apparatus embodiments of this disclosure are described below, which may be configured for performing the data transmission optimization method in the foregoing embodiments of this disclosure. For details not disclosed in the apparatus embodiments of this disclosure, reference is made to the foregoing embodiments of the data transmission optimization method in this disclosure.

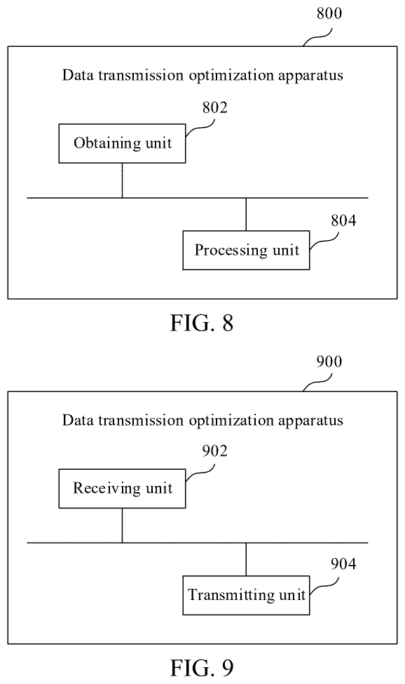

FIG. 8 is a block diagram of a data transmission optimization apparatus according to an embodiment of this disclosure. The data transmission optimization apparatus may be arranged in an ALTO client.

With reference to FIG. 8, a data transmission optimization apparatus 800 according to an embodiment of this disclosure includes an obtaining unit 802 and a processing unit 804.

The obtaining unit 802 is configured to: obtain, based on a DN, transmission information of an access network exposed by an access network device, the transmission information of the access network being exposed by the access network device to the DN; and obtain ALTO information provided by an ALTO server. The processing unit 804 is configured to perform data transmission optimization of an ALTO client based on the ALTO information and the transmission information of the access network.

In some embodiments of this disclosure, based on the foregoing solutions, the obtaining unit 802 is configured to obtain the ALTO information from the core network device, the ALTO information being obtained from the ALTO server by another ALTO client and transmitted to the core network device.

In some embodiments of this disclosure, based on the foregoing solutions, the obtaining unit 802 is configured to obtain the ALTO information from a NEF entity, the ALTO information being transmitted to the NEF entity by the another ALTO client through the DN.

In some embodiments of this disclosure, based on the foregoing solutions, the obtaining unit 802 is configured to obtain the ALTO information from an AF entity, the ALTO information being transmitted to a NEF entity by the another ALTO client through the DN, and transmitted to the AF entity by the NEF entity.

In some embodiments of this disclosure, based on the foregoing solutions, the obtaining unit 802 is configured to perform an ALTO service discovery process, and transmit an ALTO information obtaining request to the ALTO server after identifying the ALTO server; and receive the ALTO information fed back by the ALTO server.

In some embodiments of this disclosure, based on the foregoing solutions, the data transmission optimization apparatus 800 further includes a transmitting unit, configured to transmit the ALTO information to the core network device through the DN after receiving the ALTO information fed back by the ALTO server, so that the core network device exposes the ALTO information to another ALTO client.

In some embodiments of this disclosure, based on the foregoing solutions, the transmitting unit is configured to transmit the ALTO information to a UPF entity through the DN, so that the UPF entity provides the ALTO information to the another ALTO client through the NEF entity.

In some embodiments of this disclosure, based on the foregoing solutions, the obtaining unit 802 is configured to obtain, from the DN, the transmission information of the access network exposed by the access network device, the transmission information of the access network being transmitted by the access network device to the DN through the UPF entity.

In some embodiments of this disclosure, based on the foregoing solutions, the transmission information of the access network includes at least one of the following: wireless link state information, throughput, transmission delay information, and delay jitter information of an access network.

In some embodiments of this disclosure, based on the foregoing solutions, the ALTO information includes at least one of the following: IP-based dynamic network information, IP-based routing protocol unit information, and ALTO-based network configuration policy information.

FIG. 9 is a block diagram of a data transmission optimization apparatus according to an embodiment of this disclosure. The data transmission optimization apparatus may be arranged in an ALTO server.

With reference to FIG. 9, a data transmission optimization apparatus 900 according to an embodiment of this disclosure includes a receiving unit 902 and a transmitting unit 904.

The receiving unit 902 is configured to receive an ALTO information obtaining request transmitted by an ALTO client. The transmitting unit 904 is configured to expose the ALTO information to the ALTO client based on the ALTO information obtaining request, so that the ALTO client performs data transmission optimization of the ALTO client based on the ALTO information and transmission information of an access network exposed by an access network device, the transmission information of the access network being exposed by the access network device to a DN, and obtained by the ALTO client from the DN.

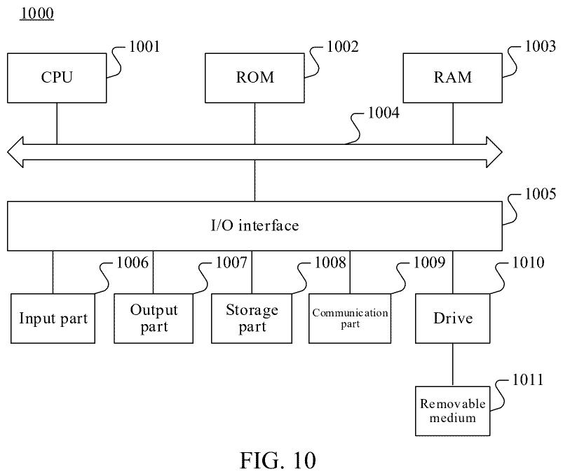

FIG. 10 is a schematic structural diagram of a computer system adapted to implement an electronic device according to an embodiment of this disclosure.

A computer system 1000 of the electronic device shown in FIG. 10 is merely an example, and does not constitute any limitation on functions and a range of application of the embodiments of this disclosure.

As shown in FIG. 10, the computer system 1000 includes a central processing unit (CPU) 1001, which may perform various suitable actions and processes based on a program stored in a read-only memory (ROM) 1002 or a program loaded from a storage part 1008 into a random access memory (RAM) 1003, for example, perform the method in the foregoing embodiments. The RAM 1003 further has various programs and data required for system operation stored therein. The CPU 1001, the ROM 1002, and the RAM 1003 are connected to each other through a bus 1004. An input/output (I/O) interface 1005 is also connected to the bus 1004.

The following components are connected to the I/O interface 1005: an input part 1006 including a keyboard, a mouse, or the like; an output part 1007 including a cathode ray tube (CRT), a liquid crystal display (LCD), a speaker, or the like; the storage part 1008 including a hard disk, or the like; and a communication part 1009 including a network interface card such as a local area network (LAN) card and a modem. The communication part 1009 performs communication processing by using a network such as the Internet. A drive 1010 is also connected to the I/O interface 1005 as required. A removable medium 1011 such as a magnetic disk, an optical disk, a magneto-optical disk, or a semiconductor memory is installed on the drive 1010 as required, so that a computer program read from the removable medium is installed into the storage part 1008 as required.

Particularly, according to the embodiments of this disclosure, the process described by referring to the flowchart in the above may be implemented as a computer software program. For example, an embodiment of this disclosure includes a computer program product, including a computer program carried on a computer-readable medium, the computer program including program code for performing the method shown in the flowchart. In such an embodiment, the computer program may be downloaded and installed from a network through the communication part 1009, and/or installed from the removable medium 1011. When the computer program is executed by the CPU 1001, various functions defined in the system of this application are performed.

The computer-readable medium described in the embodiments of this disclosure may be a computer-readable signal medium or a computer-readable storage medium or any combination of the above. The computer-readable storage medium may be, for example, but is not limited to, an electric, magnetic, optical, electromagnetic, infrared, or semi-conductive system, apparatus, or device, or any combination of the above. A more specific example of the computer-readable storage medium may include but is not limited to: an electrical connection having one or more wires, a portable computer disk, a hard disk, a RAM, a ROM, an erasable programmable ROM (EPROM), a flash memory, an optical fiber, a portable compact disk ROM (CD-ROM), an optical storage device, a magnetic storage device, or any appropriate combination of the above. In this disclosure, the computer-readable storage medium may be any tangible medium that includes or stores a program. The program may be used by or used in combination with an instruction execution system, apparatus, or device. In this disclosure, a computer-readable signal medium may include a data signal being in a baseband or propagated as a part of a carrier wave, which carries a computer-readable computer program. A data signal propagated in such a way may have a plurality of forms, including but not limited to, an electromagnetic signal, an optical signal, or any appropriate combination of the above. The computer-readable signal medium may further be any computer-readable medium other than the computer-readable storage medium. The computer-readable medium may send, propagate, or transmit a program used by or in combination with the instruction execution system, apparatus, or device. The computer program included in the computer-readable medium may be transmitted by using any suitable medium, including but not limited to a wireless medium, a wired medium, or any suitable combination of the above.

The flowcharts and block diagrams in the accompanying drawings illustrate possible system architectures, functions and operations that may be implemented by a system, a method, and a computer program product according to various embodiments of this disclosure. Each box in a flowchart or a block diagram may represent a module, a program segment, or a part of code. The module, the program segment, or the part of code includes one or more executable instructions used for implementing specified logic functions. In some alternative implementations, functions annotated in the blocks may also be executed in an order different from that annotated in the accompanying drawings. For example, actually two boxes shown in succession may be performed basically in parallel, and sometimes the two boxes may be performed in a reverse sequence. This is determined by a related function. Each box of the block diagrams or the flowcharts and combinations of boxes in the block diagrams or the flowcharts may be implemented by a dedicated hardware-based system that performs specified functions or operations, or may be implemented by a combination of dedicated hardware and a computer program.

The involved unit described in the embodiments of this disclosure may be implemented by software or hardware, and the described unit may also be arranged in a processor. Names of the units do not constitute a limitation on the units in a specific case.

In another aspect, this disclosure further provides a computer-readable medium. The computer-readable medium may be included in the electronic device described in the above embodiments, or may exist alone without being installed into the electronic device. The foregoing computer-readable medium carries one or more computer programs. The one or more computer programs, when executed by the electronic device, cause the electronic device to implement the methods described in the above embodiments.

Although a plurality of modules or units of a device configured to perform actions are mentioned in the foregoing detailed description, such division is not mandatory. In fact, according to the implementations of this disclosure, the features and functions of the two or more modules or units described above may be embodied in one module or unit. On the contrary, the features and functions of one module or unit described above may further be divided to be embodied by a plurality of modules or units.

Through the foregoing descriptions of the implementations, a person skilled in the art may readily understand that the example implementations described herein may be implemented by software, or may be implemented by combining software with necessary hardware. Therefore, the technical solutions according to the implementations of this disclosure may be embodied in a form of a software product. The software product may be stored in a non-volatile storage medium (which may be a CD-ROM, a USB flash drive, a removable hard disk, or the like) or on the network, including several instructions for enabling a computing device (which may be a personal computer, a server, a touch terminal, a network device, or the like) to perform the method according to the implementations of this disclosure.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some exemplary embodiments of this disclosure which are not intended to limit the scope of this disclosure. Other embodiments shall also fall within the scope of this disclosure.

What is claimed is:

1. A method of data transmission optimization, comprising:
obtaining, by an application layer transmission optimization (ALTO) client, and based on a data network (DN), transmission information of an access network, the transmission information of the access network being exposed by an access network device to the DN;
obtaining ALTO information that is provided by an ALTO server; and
performing the data transmission optimization of the ALTO client based on the ALTO information and the transmission information of the access network.

2. The method according to claim 1, wherein the obtaining the transmission information comprises:
obtaining, from the DN, the transmission information of the access network, the transmission information of the access network being transmitted by the access network device to the DN through a user plane function (UPF) entity.

3. The method according to claim 2, wherein the transmission information of the access network is notified by the access network device to the UPF entity through an interface N3, the transmission information of the access network is exposed by the UPF entity to the DN through an interface N6, and the transmission information of the access network is exposed by the DN to the ALTO client through an external interface.

4. The method according to claim 1, wherein the obtaining the ALTO information comprises:
obtaining the ALTO information from a core network device, the ALTO information being obtained from the ALTO server by another ALTO client, the other ALTO client transmitting the ALTO information to the core network device.

5. The method according to claim 4, wherein the obtaining the ALTO information from the core network device comprises:
obtaining the ALTO information from a network exposure function (NEF) entity, the ALTO information being transmitted to the NEF entity by the other ALTO client through the DN.

6. The method according to claim 4, wherein the obtaining the ALTO information from the core network device comprises:
obtaining the ALTO information from an application function (AF) entity, the ALTO information being transmitted to a NEF entity by the other ALTO client through the DN, and being transmitted to the AF entity by the NEF entity.

7. The method according to claim 1, wherein the obtaining the ALTO information comprises:
performing an ALTO service discovery process;
transmitting an ALTO information obtaining request to the ALTO server after identifying the ALTO server; and
receiving the ALTO information fed back by the ALTO server.

8. The method according to claim 7, further comprising:
transmitting the ALTO information to a core network device through the DN, the core network device exposing the ALTO information to another ALTO client.

9. The method according to claim 8, wherein the transmitting the ALTO information to the core network device through the DN comprises:
transmitting the ALTO information to a UPF entity through the DN, the UPF entity providing the ALTO information to the other ALTO client through a NEF entity.

10. The method according to claim 1, wherein the transmission information of the access network comprises at least one of: wireless link state information, throughput, transmission delay information, and delay jitter information of the access network.

11. The method according to claim 1, wherein the ALTO information comprises at least one of: IP-based dynamic network information, IP-based routing protocol unit information, and ALTO-based network configuration policy information.

12. The method according to claim 1, wherein the transmission information of the access network is exposed by a user plane of a 5G network.

13. A method of data transmission optimization, comprising:
receiving an ALTO information obtaining request transmitted by an ALTO client; and
exposing ALTO information to the ALTO client based on the ALTO information obtaining request, the ALTO information being used by the ALTO client that performs the data transmission optimization based on the ALTO information and transmission information of an access network, the transmission information of the access network being exposed by an access network device to the ALTO client via a DN.

14. An apparatus for data transmission optimization, comprising processing circuitry configured to:
obtain, by an application layer transmission optimization (ALTO) client of the apparatus, and based on a data network (DN), transmission information of an access network, the transmission information of the access network being exposed by an access network device to the DN;
obtain ALTO information that is provided by an ALTO server; and
performing the data transmission optimization of the ALTO client based on the ALTO information and the transmission information of the access network.

15. The apparatus according to claim 14, wherein the processing circuitry is configured to:
obtain, from the DN, the transmission information of the access network, the transmission information of the access network being transmitted by the access network device to the DN through a user plane function (UPF) entity.

16. The apparatus according to claim 15, wherein the transmission information of the access network is notified by the access network device to the UPF entity through an interface N3, the transmission information of the access network is exposed by the UPF entity to the DN through an interface N6, and the transmission information of the access network is exposed by the DN to the ALTO client through an external interface.

17. The apparatus according to claim 14, wherein the processing circuitry is configured to:
obtain the ALTO information from a core network device, the ALTO information being obtained from the ALTO server by another ALTO client, the other ALTO client transmitting the ALTO information to the core network device.

18. The apparatus according to claim 17, wherein the processing circuitry is configured to:
obtain the ALTO information from a network exposure function (NEF) entity, the ALTO information being transmitted to the NEF entity by the other ALTO client through the DN.

19. The apparatus according to claim 17, wherein the processing circuitry is configured to:
obtain the ALTO information from an application function (AF) entity, the ALTO information being transmitted to a NEF entity by the other ALTO client through the DN, and being transmitted to the AF entity by the NEF entity.

20. The apparatus according to claim 14, wherein the processing circuitry is configured to:
perform an ALTO service discovery process;
transmit an ALTO information obtaining request to the ALTO server after identifying the ALTO server; and
receive the ALTO information fed back by the ALTO server.
